(19) United States
(12) Patent Application Publication
(10) Pub. No.: US 2026/0257604 A1
(43) Pub. Date: Sep. 3, 2026

(54) METHOD FOR OPERATING A STORAGE COMPARTMENT UNIT IN A VEHICLE AND VEHICLE

(71) Applicant: MERCEDES-BENZ GROUP AG, Stuttgart (DE)

(72) Inventors: Gudrun SCHÖNHERR, Holzgerlingen (DE); Michael LAHRES, Neu-Ulm - Burlafingen (DE); Jan Theo Gerd SIEMEN, Bocholt (DE); Pascal BOLEY, Stuttgart (DE)

(21) Appl. No.: 19/125,425

(22) PCT Filed: Oct. 13, 2023
(86) PCT No.: PCT/EP2023/078581

§ 371 Date: Apr. 29, 2025

(30) Foreign Application Priority Data
Oct. 31, 2022 (DE) 10 2022 004 041.7

(51) Int. Cl. B60N 3/10; B33Y 80/00; B60Q 3/225; B60Q 3/80; B60R 7/04

(52) U.S. Cl. CPC B60N 3/104; B60Q 3/225; B60Q 3/80; B60R 7/04; B33Y 80/00

(57) ABSTRACT

A storage compartment unit in a vehicle includes a temperature control unit, a storage compartment coolable by the temperature control unit, and a storage compartment heatable by the temperature control unit. The temperature control unit is controlled to cool the coolable storage compartment and/or to heat the heatable storage compartment depending on sensor data from a sensor system of the vehicle, information from a central unit external to the vehicle, information from a personal communication unit of a vehicle user, and/or information from a communication of the vehicle user with a human-machine interface of the vehicle. The coolable storage compartment is cooled and/or the heatable storage compartment is heated when the presence of the vehicle user in the vehicle is recognized, an outside temperature in a predetermined temperature range is recognized, a predetermined activity of the vehicle user is recognized, and a predetermined operating state of the vehicle is recognized.

### BACKGROUND AND SUMMARY OF THE INVENTION

Exemplary embodiments of the invention relate to a method for operating a storage compartment unit in a vehicle, as well as to a vehicle.

A method for operating a storage compartment unit in a vehicle is known from CN 2 11 001 042 U. To carry out the known method, the vehicle has: a temperature control unit, a storage compartment that can be cooled by means of the temperature control unit, and a storage compartment that can be heated by means of the temperature control unit. The temperature control unit is controlled to cool the coolable storage compartment and/or to heat the heatable storage compartment, that is depending on sensor data from a sensor system of the vehicle and/or on information from a communication of the vehicle user with a human-machine interface of the vehicle.

A similar method for operating a storage compartment unit with two modules is described in DE 10 2014 113 860 A1. Temperature control devices enable a beverage can or similar to be cooled or heated in the modules. For this purpose, the temperature control devices are connected to a control unit and a power supply.

A further similar method is described in U.S. Pat. No. 6,637,709 B1. Moreover, a self-adjusting cup holder is described which comprises a receiving region, levelling levers, and tensioning elements for tensioning the levelling levers into a first position.

The receiving region is configured to receive a part of a drinking vessel. The levelling levers are arranged in slots in the wall of the receiving region. A first end of the levelling levers is pivotally connected to a part of the wall such that a first edge of the levers can be moved between the first position and a second position. The first edge is located inside the receiving region when the levelling levers are in the first position. The first edge is further away from the wall in the first position than in the second position.

A method for exclusively cooling a storage compartment and exclusively heating another storage compartment, albeit without a control unit, is known from KR 10 2008 0 025 990 A. A temperature control is disclosed in KR 10 2021 0 065 480 A.

DE 10 2020 004 478 A1 deals with a face mask that can be heated in a storage compartment.

In DE 10 2017 128 896 A1, an arrangement for illuminating the interior of a motor vehicle is described. The arrangement comprises a light source arranged in the interior of the motor vehicle for emitting light and for illuminating the interior. The motor vehicle has a retractable convertible top. At least one partial region of a roof lining facing towards the interior of the motor vehicle has a flat or elongated element that actively emits light, which forms at least one part of the light source for illuminating the interior and emits light over its surface or length. In addition, the one light source is arranged in the interior of the motor vehicle in such a way that the light it emits strikes the roof lining of the motor vehicle, which illuminates the interior as an indirect light source.

Exemplary embodiments of the invention are directed to an improved method in comparison to the prior art for operating a storage compartment in a vehicle and an improved vehicle in comparison to the prior art.

In a method according to the invention for operating a storage compartment unit in a vehicle, which has at least one temperature control unit, at least one storage compartment which can be cooled by means of the temperature control unit, and at least one storage compartment which can be heated by means of the temperature control unit, it is provided that the temperature control unit is controlled for cooling the coolable storage compartment and/or for heating the heatable storage compartment depending on sensor data of a sensor system of the vehicle and/or on information from a central unit external to the vehicle, in particular on a so-called backend, and/or on information from a personal, in particular mobile, communication unit, in particular a mobile telephone, of a vehicle user and/or on information from a communication of the vehicle user with a human-machine interface of the vehicle, wherein it is essentially provided in the invention that the coolable storage compartment is cooled and/or the heatable storage compartment is heated in the event of a detected presence of the vehicle user in the vehicle, a detected outside temperature in a predetermined temperature range, a detected predetermined activity of the vehicle user, and a detected predetermined operating state of the vehicle. This activation of the cooling and/or heating can thus be adjusted directly to an outside temperature and/or activity of the vehicle user, for example. For example, after starting a journey or after starting a charging process of the vehicle designed as an electric vehicle, the coolable storage compartment can thus be cooled when the vehicle user is recognized as being present in the vehicle and an outside temperature is above 30° C., and as soon as the predetermined temperature of, for example, 16° C. is reached in this storage compartment, the lighting unit of this storage compartment is activated, which then lights up blue for practical purposes. Thus, the vehicle user is reminded to remove and use the cooled object, for example the face mask, in order to relax.

A vehicle according to the invention has at least one storage compartment unit operated by means of this method. The storage compartment unit has the at least one temperature control unit, the at least one storage compartment which can be cooled by means of the temperature control unit, and the at least one storage compartment which can be heated by means of the temperature control unit. In addition, the storage compartment unit is advantageously coupled to the sensor system of the vehicle and/or to the central unit external to the vehicle and/or to the personal, in particular mobile, communication unit of the vehicle user and/or to the human-machine interface for communication between the vehicle user and the vehicle, at least temporarily, at least for a data transmission connection.

In particular, it is provided that, for example, a face mask and/or eye cover and/or a face cloth for the vehicle user is cooled by means of the coolable storage compartment and/or, for example, a scarf and/or a blanket and/or a face mask and/or a face cloth for the vehicle user is heated by means of the heatable storage compartment. These objects serve in particular to relax the vehicle user, for example while the vehicle is travelling, when the vehicle user is not the driver of the vehicle themselves or during an automatic, in particular highly automatic or autonomous, driving mode of the vehicle, or when the vehicle is stationary, for example during a charging stop when the vehicle is formed as an electric vehicle or hybrid vehicle. Here, the vehicle user can, for example, recline their vehicle seat into a so-called relax position, i.e., into a reclined position or at least into a position with the seat backrest tilted backwards, and place the cooled or warmed face mask or the cooled or warmed face cloth or the cooled eye cover, in particular in the form of eye pads, and/or put on the warmed scarf and/or cover themselves with the warmed blanket for further relaxation. The solution according to the invention thus enables an increase in comfort for the vehicle user.

The temperature control unit is formed, in particular, as a Peltier element. In particular, it is provided that the temperature control unit is arranged between the two storage compartments. Such a Peltier element can cool quickly. However, the Peltier element has a cold side and a warm side. Until now, the disadvantage of using Peltier elements has often been that heat from the hot side is dissipated unused. In the solution described here, both sides of the Peltier element are used effectively. The coolable storage compartment is cooled by means of the cold side, and the heatable storage compartment is heated by means of the warm side, advantageously at the same time.

The temperature control unit formed as a Peltier element is thus advantageously arranged between the two storage compartments in such a way that heat from the warm side of the Peltier element is radiated into the heatable storage compartment and cold from the cold side of the Peltier element is radiated into the coolable storage compartment. This achieves particularly good energy utilization.

In particular in order to further optimize this energy utilization, it is advantageously provided that the two storage compartments are arranged one above the other, i.e., in two tiers. In particular, it is here provided that the coolable storage compartment is arranged at the bottom and the heatable storage compartment at the top. This prevents heat from the heatable storage compartment from reaching and heating the coolable storage compartment. Alternatively, other arrangements of the storage compartments can also be provided, for example next to each other.

A connection between the temperature control unit, in particular formed as a Peltier element, and the storage compartments is formed in such a way that heat conduction from the temperature control unit to the respective storage compartment is optimized. For example, this can be achieved by using material with good thermal conductivity between the temperature control unit and the respective storage compartment. For this purpose, for example, at least one wall of the respective storage compartment adjacent to the temperature control unit is made of this material. Alternatively or additionally, a flat thermal contact is advantageously provided between the respective storage compartment and the temperature control unit or a heat conducting channel structure is provided between the respective storage compartment and the temperature control unit.

The two storage compartments are advantageously each formed as a chamber, i.e., they each have, in particular, only a relatively small opening for depositing objects and for removing the objects. An opening area of the opening is in particular smaller, in particular substantially smaller, than an entire wall area of the respective storage compartment. Thus, good thermal shielding of an interior of the respective storage compartment from an external environment is ensured.

Advantageously, a lighting unit is allocated to each of the two storage compartments. In particular, it is here provided that the lighting unit allocated to the coolable storage compartment emits a different light color to the lighting unit allocated to the heatable storage compartment. For example, the lighting unit allocated to the coolable storage compartment lights up blue, and the lighting unit allocated to the heatable storage compartment lights up red, for example. In particular, it is provided in the method that the respective lighting unit is activated when a respective predetermined event occurs. For example, the respective lighting unit is activated when a predetermined temperature is reached in the storage compartment to which the respective lighting unit is allocated. The lighting units provide the vehicle user with a visual indication that the temperature-controlled storage compartments are available, for example.

The respective lighting unit has, for example, a light guide and a light source. The light source is formed as an LED (light-emitting diode), for example. In particular, the respective lighting unit is arranged in the respective storage compartment, for example integrated into it.

In a possible embodiment, at least one housing of the storage compartment unit is produced by means of an additive manufacturing process, in particular by means of a three-dimensional printing process. Thus, for example, the heat conduction channel structures can also be generated and/or heat-conducting materials and/or structures for targeted heat conduction of the heat or cold from the temperature control unit into the respective storage compartment can be incorporated into the housing. For example, the light guides of the lighting units are also generated by means of this additive manufacturing process. A material with good thermal conductivity is advantageously used for additive manufacturing, such that the heat or cold from the temperature control unit is optimally conducted into the respective storage compartment, in particular around the interior of the respective storage compartment. Additive manufacturing furthermore makes it possible, for example, to adjust the housing in terms of shape, color, and/or material to customer requirements and/or existing installation space conditions in a respective vehicle, in particular in the region of a respective vehicle seat of the vehicle.

In order to monitor the temperature in the respective storage compartment, for example, a temperature sensor can be provided in the respective storage compartment. This can ensure that a predetermined temperature is reached in the respective storage compartment and then kept constant. For example, the vehicle user can also be informed via the human-machine interface when the predetermined temperature is reached, in particular by means of voice output or visual output.

For example, the lighting units can also serve to communicate with the vehicle user. For example, at a hot outside temperature, i.e., within a predetermined high temperature range, by activating the lighting unit allocated to the coolable storage compartment, whereby it advantageously lights up blue, and/or by its flashing and/or increased illumination, the vehicle user can be made a targeted offer to use the object cooled in this coolable storage compartment, for example the face mask and/or eye cover and/or the face cloth. For example, this can, alternatively or additionally, also be offered to the vehicle user via the human-machine interface for communication between the vehicle user and the vehicle, in particular acoustically, in particular by means of a voice output, or can be requested by the vehicle user. For example, the corresponding lighting unit is activated in response to this request from the vehicle user, i.e., the lighting unit allocated to the coolable storage compartment when a request is made for a cooled object, which then lights up blue in particular, and the lighting unit allocated to the heatable storage compartment when a request is made for a heated object, which then lights up red in particular.

The storage compartment unit is advantageously positioned in the vehicle within reach of the hands of the vehicle user, particularly when they are in the reclined position described above. Here, it can be provided, for example, that the openings of the storage compartments are only accessible when the vehicle seat is positioned in the relax position. In this way, for example, the openings of the storage compartments can be closed or at least shielded from their external surroundings by the vehicle seat as long as it is not in the relax position, whereby a degree of energy efficiency when cooling or heating the respective storage compartment is further optimized.

The storage compartment unit can be arranged in a center console or fixed armrest of the vehicle, for example. For example, it is 15 cm long, 12 cm wide and 4 cm high. However, other dimensions are also possible. The openings of the storage compartments are here located below an upper cover of the center console or armrest, for example. In particular, they are positioned in such a way that they are accessible to the vehicle user sitting in the vehicle seat, yet only when the vehicle seat is in the reclined position, for example.

To control the storage compartment unit, it expediently has a control device. The control device is coupled with the temperature control unit to control it. Advantageously, the lighting units are also coupled to the control device and are thus activated and deactivated by it. For example, the temperature sensors allocated to the storage compartments are coupled to the control device. This ensures that the predetermined temperature is reached and maintained in the respective storage compartment by the control unit correspondingly controlling the temperature control unit. Expediently, the sensor system of the vehicle and/or the vehicle-external central unit and/or the personal communication unit of the vehicle user and/or the human-machine interface for communication between the vehicle user and the vehicle are also coupled to the control unit at least temporarily, at least for the data transmission connection.

Exemplary embodiments of the invention are explained in more detail below by means of a drawing.

### BRIEF DESCRIPTION OF THE SOLE DRAWING FIGURE

Here is shown in:

The sole drawing FIGURE, schematically, a vehicle with a storage compartment unit.

### DETAILED DESCRIPTION

The sole drawing FIGURE shows a schematic depiction of an exemplary embodiment of a vehicle 1 with a storage compartment unit 2.

The storage compartment unit 2 has two storage compartments A1, A2, between which a temperature control unit 3 designed as a Peltier element is arranged. A cold side of the Peltier element is thus thermally coupled to one storage compartment A1, which can thus be cooled, and a warm side of the Peltier element is thermally coupled to the other storage compartment A2, which can thus be heated.

An energy flow arrow P is used to schematically depict the resulting energy flow in the sole drawing FIGURE. Heat is absorbed by the Peltier element from the coolable storage compartment A1, whereby this storage compartment A1 is cooled, and heat is emitted to the heatable storage compartment A2, whereby this is heated.

In the example depicted, the two storage compartments A1, A2 are arranged one above the other, i.e., on two levels. Here, in the example depicted, the coolable storage compartment A1 is arranged above the heatable storage compartment A2. In order to avoid or at least further reduce heating of the coolable storage compartment A1 by the heat of the heatable storage compartment A2 and thus improve a degree of energy efficiency of the storage compartment unit 2, the reverse arrangement of the two storage compartments A1, A2 can be provided in other embodiments, i.e., the coolable storage compartment A1 is then arranged below the heatable storage compartment A2.

A connection between the temperature control unit 3, which is formed as a Peltier element in the example depicted, and the storage compartments A1, A2 is formed, in particular, in such a way that heat conduction from the temperature control unit 3 to the respective storage compartment A1, A2 is optimized. For example, this can be achieved by using a material with good thermal conductivity, in particular a material with a high temperature coefficient of conductivity, between the temperature control unit 3 and the respective storage compartment A1, A2. For this purpose, for example, at least one wall of the respective storage compartment A1, A2 adjacent to the temperature control unit 3 is made of this material. Alternatively or additionally, a flat thermal contact between the respective storage compartment A1, A2 and the temperature control unit 3 is advantageously provided, as shown in the sole drawing FIGURE. Here, the temperature control unit 3 is integrated into an intermediate wall between the two storage compartments A1, A2 and is thermally coupled to this intermediate wall in the direction of the respective storage compartment A1, A2 over a large surface, in particular over the entire surface. Alternatively or additionally, a heat conducting channel structure 4 can be provided between the respective storage compartment A1, A2 and the temperature control unit 3. In the example depicted here, such a heat conduction channel structure 4 is formed by a perforated structure of the intermediate wall at least in the region of the temperature control unit 3 in the direction of the respective storage compartment A1, A2.

As shown schematically in the sole drawing FIGURE, the two storage compartments A1, A2 are advantageously each formed as a chamber, i.e., they each have, in particular, only a relatively small opening for depositing objects O in the respective storage compartment A1, A2 and for removing the objects O from the respective storage compartment A1, A2. An opening surface of the opening is in particular smaller, in particular substantially smaller, than an entire wall surface of the respective storage compartment A1, A2. This ensures good thermal shielding of an interior of the respective storage compartment A1, A2 from an external environment.

In the example depicted, the two storage compartments A1, A2 are also each allocated a lighting unit B1, B2. In particular, it is here provided that the lighting unit B1 allocated to the coolable storage compartment A1 emits a different light color to the lighting unit B2 allocated to the heatable storage compartment A2. For example, the lighting unit B1 allocated to the coolable storage compartment A1 lights up blue and the lighting unit B2 allocated to the heatable storage compartment A2 lights up red, for example.

In the example depicted, the respective lighting unit B1, B2 has a light guide 5 and a light source 6. In the example depicted, the light source 6 is formed as an LED, in particular as an RGB LED, such that the different light colors described above can be generated.

The respective lighting unit B1, B2 is arranged in particular in the respective storage compartment A1, A2, for example integrated into it. In the example depicted, the respective light guide 5 runs along a rear side of the respective storage compartment A1, A2 and along a top side of the upper storage compartment A1 or along a bottom side of the lower storage compartment A2 into a region of the opening. The thermal coupling of the temperature control unit 3 with the storage compartments is thus not influenced by the light guides 5.

In the example depicted, the light sources 6 are each arranged at a light coupling point of the respective light guide 5 in the rear wall of the respective storage compartment A1, A2. Light decoupling points 7, in particular light decoupling structures formed in the respective light guide 5, are provided in the example depicted, in particular at end regions of the respective light guide 5 facing away from the light coupling point, in the example depicted on the rear wall of the respective storage compartment A1, A2 and in the region of the opening of the respective storage compartment A1, A2. Thus, illumination of the entire respective storage compartment A1, A2 and also increased illumination of the opening region of the respective storage compartment A1, A2 is achieved, whereby the light is also visible from the outside, in particular for a vehicle user.

In order to monitor a temperature in the respective storage compartment A1, A2, for example, a temperature sensor (not depicted here) can be provided in the respective storage compartment A1, A2. This can ensure that a predetermined temperature is reached in the respective storage compartment A1, A2 and then kept constant.

For example, at least one housing 8 of the storage compartment unit 2 is produced by means of an additive manufacturing process, in particular by means of a three-dimensional printing process, also known as 3D printing. In this way, for example, the heat conduction channel structures 4 can also be produced and/or heat-conducting materials and/or structures can be incorporated into the housing 8 for targeted heat conduction of the heat or cold from the temperature control unit 3 into the respective storage compartment A1, A2. For example, the light guides 5 of the lighting units B1, B2 are also produced by means of this additive manufacturing process. For example, at least components of the light sources 6 can also be generated by means of this additive manufacturing process.

For additive manufacturing, a material with good thermal conductivity is advantageously used such that the heat or cold is optimally conducted from the temperature control unit 3 into the respective storage compartment A1, A2, in particular around the interior of the respective storage compartment A1, A2. Furthermore, additive manufacturing makes it possible, for example, to adjust the housing 8 in terms of shape, color and/or material to customer requirements and/or existing installation space conditions in a respective vehicle 1, in particular in the region of a respective vehicle seat of the vehicle 1.

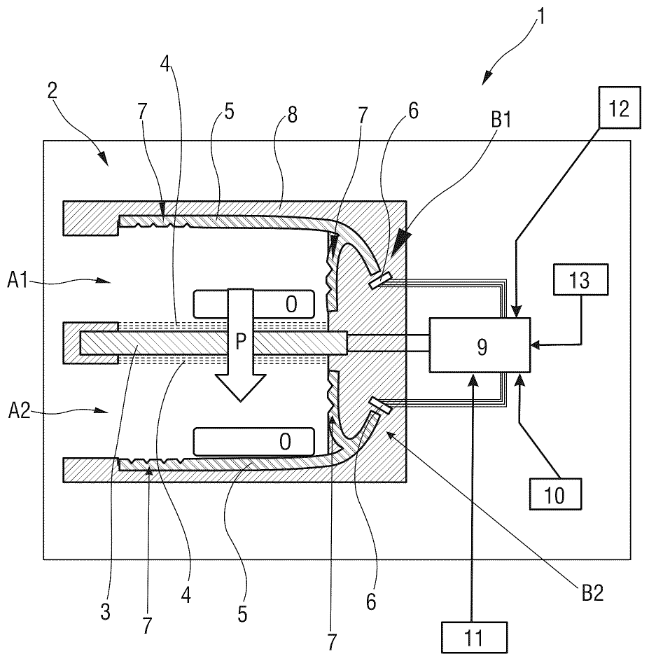

In particular, it is provided that, for example, a face mask and/or eye cover and/or a face cloth for the vehicle user is cooled by means of the coolable storage compartment A1 and/or, for example, a scarf and/or a blanket and/or a face mask and/or a face cloth for the vehicle user is heated by means of the heatable storage compartment A2. The objects O depicted by of example in the storage compartments A1, A2 in FIG. 1 are thus advantageously formed in such a way.

These objects O serve in particular to relax the vehicle user, for example while the vehicle 1 is travelling, when the vehicle user is not the vehicle driver, or during an automatic, in particular highly automatic or autonomous, driving mode of the vehicle 1, or when the vehicle 1 is stationary, for example during a charging stop, when the vehicle 1 is formed as an electric vehicle or hybrid vehicle.

Here, the vehicle user can, for example, adjust their vehicle seat to a so-called relax position, i.e., to a reclined position or at least to a position with the seat backrest tilted backwards, and put on the cooled or heated face mask or the cooled or heated face cloth or the cooled eye cover, in particular in the form of eye pads, and/or put on the heated scarf and/or cover themselves with the heated blanket in order to relax further.

The storage compartment unit 2 is thus advantageously positioned in the vehicle 1 within reach of the hands of the vehicle user, in particular when they are in the relax position in the vehicle seat. Here, it can be provided, for example, that the openings of the storage compartments A1, A2 are only accessible when the vehicle seat is positioned in the relax position. In this way, for example, a closure or at least a shielding of the openings of the storage compartments A1, A2 from their external environment can be achieved by the vehicle seat as long as they are not in the relax position, whereby a degree of energy efficiency in the cooling or heating of the respective storage compartment A1, A2 is further optimized.

The storage compartment unit 2 can, for example, be arranged in a center console or fixed armrest of the vehicle 1. For example, it is 15 cm long, 12 cm wide and 4 cm high. However, other dimensions are also possible. The openings of the storage compartments A1, A2 are here located below an upper cover of the center console or armrest, for example. In particular, they are positioned in such a way that they are accessible to the vehicle user sitting in the vehicle seat, yet only when the vehicle seat is in the relax position, for example.

To control the storage compartment unit 2, it has a control device 9 in the example depicted, which is coupled with the temperature control unit 3 and the light sources 6 of the lighting units B1, B2 for their control and electrical power supply. The temperature sensors allocated to the storage compartments A1, A2, which are not depicted here, are also expediently coupled to the control unit 9. This ensures that the predetermined temperature in the respective storage compartment A1, A2 is reached and kept constant by the control unit 9 correspondingly controlling the temperature control unit 3. In addition, the respective lighting unit B1, B2 can be activated by means of the control unit 9, in particular when the predetermined temperature is reached in the respective storage compartment A1, A2.

In the example depicted, it is furthermore provided that the storage compartment unit 2, or more precisely its control unit 9, is coupled at least temporarily to a sensor system 10 of the vehicle 1 and/or to a central unit 11 external to the vehicle and/or to a personal, in particular mobile, communication unit 12 of the vehicle user and/or to a human-machine interface 13 for communication between the vehicle user and the vehicle 1, at least for a data transmission connection.

The central unit 11 external to the vehicle is in particular a so-called backend, in particular of a manufacturer of the vehicle 1, in particular for providing services and/or facilities. The personal communication unit 12 of the vehicle user is, in particular, a mobile phone, in particular a smartphone. For example, the storage compartment unit 2, in particular its control unit 9, is here coupled at least temporarily to one or more apps installed on it, in particular for transmitting information. In particular, the human-machine interface 13 enables voice communication between the vehicle user and the vehicle 1 and thus also between the vehicle user and the storage compartment unit 2, in particular its control unit 9. The sensor system 10 of the vehicle 1 comprises, for example, an outside temperature sensor for ascertaining an outside temperature of an external environment of the vehicle 1 and/or an occupant detection sensor system for detecting the presence of the vehicle user in the vehicle 1 and/or a seat adjustment sensor system for detecting a seat adjustment of the vehicle seat, in particular whether or not it is in the relax position.

In a method for operating the storage compartment unit 2, it is provided in particular that the temperature control unit 3 is controlled for cooling the coolable storage compartment A1 and/or for heating the heatable storage compartment A2 depending on sensor data from the sensor system 10 of the vehicle 1 and/or on information from the central unit 11 external to the vehicle and/or on information from the personal communication unit 12 and/or on information from a communication of the vehicle user with the human-machine interface 13 of the vehicle 1. Furthermore, it is provided in particular that the respective lighting unit B1, B2 is activated when a respective predetermined event occurs. For example, the respective lighting unit B1, B2 is activated when the predetermined temperature is reached in the storage compartment A1, A2 to which the respective lighting unit B1, B2 is allocated. For example, the vehicle user can also be informed via the human-machine interface 13 that the predetermined temperature has been reached, in particular by means of voice output or visual output.

For example, the lighting units B1, B2 provide the vehicle user with an optical indication of the range of the temperature-controlled storage compartments A1, A2.

In a possible embodiment of the method, it is provided, for example, that the coolable storage compartment A1 is cooled and/or the heatable storage compartment A2 is heated when the presence of the vehicle user in the vehicle 1 is detected, an outside temperature in a predetermined temperature range is detected, a predetermined activity of the vehicle user is detected, and a predetermined operating state of the vehicle 1 is detected. Thus, this activation of cooling and/or heating can, for example, be directly adjusted to an outside temperature and/or activity of the vehicle user. For example, after starting a journey or after starting a charging process of the vehicle 1, which is formed as an electric vehicle, with a recognized vehicle user present in the vehicle 1 and an outside temperature above 30° C., the coolable storage compartment A1 can be cooled and as soon as the predetermined temperature of, for example, 16° C. is reached in this storage compartment A1, the lighting unit B1 of this storage compartment A1 can be activated, which then expediently lights up blue. This reminds the vehicle user to remove and use the cooled object O, for example the face mask, in order to relax.

For example, the lighting units B1, B2 can also serve to communicate with the vehicle user. For example, when the outside temperature is hot, i.e., within a predetermined high temperature range, by activating the lighting unit B1 allocated to the coolable storage compartment A1, whereby it advantageously lights up blue, and/or by its flashing and/or increased illumination, a specific offer can be made to the vehicle user to use the object O cooled in this coolable storage compartment A1, for example the face mask and/or eye cover and/or face cloth. For example, this can, alternatively or additionally, also be offered to the vehicle user via the human-machine interface 13 for communication of the vehicle user with the vehicle 1, in particular acoustically, in particular by means of a voice output, or can be requested by the vehicle user. For example, the corresponding lighting unit B1, B2 is activated in response to this request from the vehicle user, i.e., the lighting unit B1 allocated to the coolable storage compartment A1 is activated in response to a request for a cooled object O, which then lights up blue in particular, and the lighting unit B2 allocated to the heatable storage compartment A2 is activated in response to a request for a heated object O, which then lights up red in particular.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. A method for operating a storage compartment unit in a vehicle, wherein the storage compartment unit has a temperature control unit, a coolable storage compartment coolable by the temperature control unit, and a heatable storage compartment heatable the temperature control unit, the method comprising:
controlling the temperature control unit to cool the coolable storage compartment or heat the heatable storage compartment depending on sensor data from a sensor system of the vehicle, information from a central unit external to the vehicle, information from a personal communication unit of a vehicle user, or information from a communication of the vehicle user with a human-machine interface of the vehicle,
wherein the coolable storage compartment is cooled or the heatable storage compartment is heated when a presence of the vehicle user in the vehicle is detected, an outside temperature is within a predetermined temperature range, a predetermined activity of the vehicle user is recognized, and a predetermined operating state of the vehicle is recognized.

11. The method of claim 10, wherein the coolable storage compartment includes a first illumination unit and the heatable storage compartment includes a second illumination unit, wherein the first illumination unit emits a different light color than the second illumination unit, and wherein the first illumination unit and the second illumination unit is activated when a respective predetermined event occurs.

12. The method of claim 11, wherein the first lighting unit is activated when a first predetermined temperature is reached in the coolable storage compartment and the second lighting unit is activated when a second predetermined temperature is reached in the heatable storage compartment.

13. The method of claim 10, wherein
the coolable storage compartment cools a face mask, eye cover, or a face cloth for the vehicle user, or
the heatable storage compartment heats a scarf, a blanket, a face mask, or a face cloth for the vehicle user.

14. A vehicle comprising:
a storage compartment unit, which comprises
a temperature control unit,
a coolable storage compartment configured to be cooled by the temperature control unit; and
a heatable storage compartment configured to be heated by the temperature control unit,
wherein the storage compartment unit is coupled to a sensor system of the vehicle, a central unit external to the vehicle, a personal communication unit of a vehicle user, or a human-machine interface configured to communicate with the vehicle user with the vehicle at least temporarily at least for a data transmission connection, and
wherein temperature control unit is configured to cool the coolable storage compartment or heat the heatable storage compartment when a presence of the vehicle user in the vehicle is detected, an outside temperature is within a predetermined temperature range, a predetermined activity of the vehicle user is recognized, and a predetermined operating state of the vehicle is recognized.

15. The vehicle of claim 14, wherein the coolable storage compartment includes a first illumination unit and the heatable storage compartment includes a second illumination unit, wherein the first illumination unit emits a different light color than the second illumination unit, and wherein the first illumination unit and the second illumination unit is activated when a respective predetermined event occurs.

16. The vehicle of claim 14, wherein the temperature control unit is a Peltier element arranged between the coolable and heatable storage compartments.

17. The vehicle of claim 14, wherein the coolable storage compartment is arranged below the heatable storage compartment.

18. The vehicle of claim 14, wherein at least one housing of the storage compartment unit is produced by an additive manufacturing method.
